(19) United States
(12) Patent Application Publication
(10) Pub. No.: US 2012/0087850 A1
(43) Pub. Date: Apr. 12, 2012

(54) Process for Obtaining Apatite Concentrates by Flotation

(76) Inventors: Sebastião Eduardo De Rezende, Araxa - MG (BR); Josiane Silvia Martins, Araxa - MG (BR); Elves Matiolo, Araxa - MG (BR); Lauro Akira Takata, Araxa - MG (BR)

(21) Appl. No.: 13/377,279

(22) PCT Filed: Jun. 9, 2010
(86) PCT No.: PCT/BR10/00183

§ 371 Date: Dec. 9, 2011

(30) Foreign Application Priority Data
Jun. 9, 2009 (BR) PI0902233-3

(51) Int. Cl. C01B 25/32

(52) U.S. Cl. 423/157.3; 423/157.2

(57) ABSTRACT

The present invention, named Bunge/Fosfertil process, is applicable at different lithologies of phosphate ore with carbonated-silica matrix from igneous and sedimentary sources, i.e., consists of comminutioning the ore by crushing, homogenization, milling and disliming, prior to the apatite flotation. The dislimed and milled ore pulp with solids concentration above 40%, being initialy conditioned with a depressor reactant, a vegetable source polymer gelled with sodium hydroxide solution; and subsequently, submitted to a conditioning with a scavenger reactant of the sulphosuccinate or sulphosuccinamate groups. This pulp conditioned with reactants goes to the apatite flotation in a circuit comprising the “rougher”, “scavenger”, “cleaner” and “recleaner” steps. In all steps of the circuit flotation the carbon dioxide gas may be added up to saturation of such gas in the temperature and pressure conditions of the pulp. The system to generate bubbles for flotation works independently, being feed with atmospheric air for the self-aspirated machines or compressed air for the flotation cells with air insufflation and notation columns. The final concentrate of apatite is the flotated portion of the last cleaning step of the flotation circuit.

### CROSS-REFERENCE TO RELATED APPLICATIONS

This application claims the priority, under 35 U.S.C. §§119, 120, 363, and 371, of Brazilian patent application No. PI0902233-3 filed on Jun. 9, 2009, and International Application No. PCT/BR2010/00183 filed on Jun. 9, 2010, which designated the United States and was published in English; the prior applications are herewith incorporated by reference in their entirety.

### STATEMENT REGARDING FEDERALLY SPONSORED RESEARCH OR DEVELOPMENT

Not Applicable

### FIELD OF THE INVENTION

The present invention refers to the invention of a process, in the knowledge field of ore engineering, more specifically, of the ores treatment field to obtain apatite concentrates by flotation from phosphate ores with predominantly carbonated-silica matrix from sedimentary and igneous source using mechanical flotation machines or column cells.

### BACKGROUND OF THE INVENTION

The apatite concentration in ores containing variable amounts of silicates and carbonates has been presented as a great challenge in many phosphate ores throughout the world, either being of sedimentary source or magnetic source. Over decades, researchers all around the Word have been dedicated themselves for studying methods of selective separation between the apatite and carbonates, mainly calcite and dolomite.

In Brazil, Bunge Fertilizantes operates an industrial unit of concentration at Cajati-SP, in which the apatite ore is separated from carbonates, silicates, iron oxides and from other ores by direct flotation of apatite in synthetic collector, using corn starch as the depressor of carbonates and other gangue ores. This process of concentrating apatite was applied in other ores of igneous source from different regions of Brazil, but all the studies concerning this matter showed negative results, mainly due to the difficulties of the selective separation between apatite and carbonates.

### DETAILED DESCRIPTION OF THE INVENTION

In view of the difficulties found for the direct flotation of apatite in silica-carbonated ores several studies were focused on the concentration of apatite via reverse flotation of carbonates using a fat acid as the scavenger reactant, corn starch as the depressor reactant, the flotation being conducted in alkaline pH. This pulp is fluctuated and conditioned with sulphuric and phosphoric acids in order to achieve pH range between 4.0 to 5.0, then the carbonates flotation being effected for obtaining the apatite concentrate at the deepened fraction of such carbonates reverse flotation.

The mayor cause of difficulties found on separating apatite from carbonates is the similarity of behavior of these ores on over the anionic flotation with fat acids or synthetic reactants. Thus, the separation of these ores becomes effective only using large amounts of reactants comprising soluble phosphorus or fluorine as apatite depressor in the carbonates reverse flotation, contaminating the water and making impossible its reuse in any other circuit of flotation comprising apatite and carbonates together.

The present invention consists of effecting the comminution of phosphate ore comprising variable amounts of silicates and carbonates by crushing, homogenization, milling and disliming, prior to the apatite flotation.

The granulometry of the ore followed milling may be such that it provides the effective release of the ores to be separated, that is, the apatite and the gangue ores.

The flotation process begins by conditioning the ore pulp, previously milled and dislimed, with the depressor reactant, such as a vegetable starch gelled with a sodium hydroxide solution. Just after the conditioning with the depressor reactant, the same ore pulp is submitted to a conditioning with the scavenger reactant, such as a reactant of the sulphosuccinate or sulphosuccinamate groups.

The flotation circuit may be constituted by the “rougher”, “scavenger”, “cleaner” and “recleaner” steps, depending on the content of apatite in the ore and the kind of impurity to be removed from the process. Usually, the “rougher” and “scavenger” stages are liable for the apatite recovery, while, the “cleaner” and “recleaner” steps provide the cleaning of the flotated portion on the recovery stages. The flotation circuit may be settled only with mechanical cells and with notation columns or mixed systems.

In all steps of the flotation circuit the carbon dioxide dosage can occur as the modifier reactant of the apatite and carbonate surfaces. The carbon dioxide gas is added to the pulp through the bubble generation systems commonly used in notation machines, such as, porous plates, porous tubes, “spargers”, “cavitation tube” etc. The dosage of carbon dioxide should be controlled in order to assure the dissolution of such gas on the liquid phase up saturation at the temperature and atmospheric pressure conditions of the pulp on flotation, in addition to the formation of CO₂ microbubbles which will interact with the carbonate and apatite surfaces. Independent systems fed with atmospheric air on self-aspirated cells and compressed air in other models of mechanical cells and flotation columns are used for the bubbles formation for flotation.

Following are presented some examples to illustrate the described process, but not being limited to them:

### EXAMPLE 1

A sample of phosphate ore with carbonated-silica matrix, named phlogopitite, from Chapadão mine at Catalão-GO comprising 9.5% P₂O₅ 20.3% CaO, 9.3% Fe₂O₃ 20.8% SiO₂ and 18.3% MgO, was submitted to crushing, homogenization, milling and disliming operations. An aliquot of the prepared sample, 1000 g, was repulped for a concentration of bulk solids at about 50% and conditioned with corn meal gelled with NaOH solution, and then being conditioning with sodium sulphosuccinate. The flotation was carried out on workbench's mechanical cells in “rollgher” and “cleaner” stages at open circuit, with insufflations of carbon dioxide gas in both stages. The final concentrate presented a content of 37.3% P₂O₅ for an apatite recovery of 66.5%.

### EXAMPLE 2

A sample of phlogopitite prepared according to the disclosed in the Example 1 was submitted to a continuous assay in pilot scale. Initially, the pulp comprising 45% solids by weight was conditioned with the depressor reactant, then a corn meal gelled with NaOH solution was conditioned with sodium sulfossuccinate. The flotation was carried out at a circuit with “rougher” and “cleaner” steps assembled with 2 inch diameter columns and carbon dioxide gas insufflation at the two stages of the flotation. The final concentration presented a content of 36.1% P₂O₅ for an apatite recovery of 69.4%.

### EXAMPLE 3

A sample of phosphate ore with carbonated-silica matrix, named phlogopitite, from Chapadão mine at Catalão-GO comprising 8.24% P₂O₅, 28.61% CaO, 17.43% Fe₂O₃, 6.65% de SiO₂, 9.84% MgO, of the prepared sample, 1000 g, was repulped for a concentration of bulk solids at about 50% and conditioned with corn meal gelled with NaOH solution, and then being conditioning with sodium sulphosuccinate. The flotation was carried out on workbench's mechanical cells in “rollgher” and “cleaner” stages at open circuit, with insufflations of carbon dioxide gas in both stages. The final concentrate presented a content of 37.3% P₂O₅ for an apatite recovery of 72.5%.

### EXAMPLE 4

A sample of phlogopitite prepared according to the disclosed in Example 3 was submitted to a continuous assay in pilot scale. Initially, the pulp comprising 45% solids by weight was conditioned with the depressor reactant, then a corn meal gelled with NaOH solution was conditioned with sodium sulfossuccinate. The flotation was carried out at a circuit with “rougher” and “cleaner” steps assembled with 2 inch diameter columns and carbon dioxide gas insufflation at the two stages of the flotation. The final concentrate presented a content of 34.4% P₂O₅ for a 64.3% apatite recovery.

1. “PROCESS FOR OBTAINING APATITE CONCENTRATES BY FLOTATION”, applicable to several lithologies of phosphate ores with carbonated-silica matrix from igneous or sedimentary source, characterized by comprising the following steps:
a. comminutioning of ore by crushings, homogenization, milling in bar and ball mills in order to provide an ore with suitable apatite and gangue ores releases;
b. disliming in hydrociclons of different sizes, in order to remove effectively the slurry harmful to the apatite flotation process;
c. conditioning the pulp, initially with a vegetable polymer gelled with sodium hydroxide solution; and subsequently, conditioning with a scavenger reactant of the sulphosuccinate or sulphosuccinamate groups;
d. flotationing apatite in a circuit with “rougher”, “scavenger”, “cleaner” and “recleaner” composed by mechanical cells, flotation columns or mixed circuits with both equipments.

2. “PROCESS FOR OBTAINING APATITE CONCENTRATES BY FLOTATION”, according to claim 1, characterized by using the carbon dioxide as the modifier agent of the carbonates and apatite surfaces in order to allow the selective separation of the apatite from carbonates by flotation.

3. “PROCESS FOR OBTAINING APATITE CONCENTRATES BY FLOTATION”, according to claim 1, characterized by using the carbon dioxide gas as the reactant which modulates the pulp pH in order to provide a pH in the range of 5,8 to 6,8 on flotation.

4. “PROCESS FOR OBTAINING APATITE CONCENTRATES BY FLOTATION”, according to claim 1, characterized by using the carbon dioxide gas in all steps of the flotation or only in the cleaning stages, “cleaner” and “recleaner”, always insufflated in flotation cells through suitable mechanisms for this aim.

5. “PROCESS FOR OBTAINING APATITE CONCENTRATES BY FLOTATION”, according to claim 1, characterized by using carbon dioxide gas as the flotation reactant and atmospheric air to generate bubbles for flotation on self-aspirated flotation cells or compressed air to generate bubbles for flotation in columns or for flotation in mechanical cells with air insufflation.

6. “PROCESS FOR OBTAINING APATITE CONCENTRATES BY FLOTATION”, according to claim 2, characterized by using the carbon dioxide gas in all steps of the flotation or only in the cleaning stages, “cleaner” and “recleaner”, always insufflated in flotation cells through suitable mechanisms for this aim.

7. “PROCESS FOR OBTAINING APATITE CONCENTRATES BY FLOTATION”, according to claim 3, characterized by using the carbon dioxide gas in all steps of the flotation or only in the cleaning stages, “cleaner” and “recleaner”, always insufflated in flotation cells through suitable mechanisms for this aim.

8. “PROCESS FOR OBTAINING APATITE CONCENTRATES BY FLOTATION”, according to claim 2, characterized by using carbon dioxide gas as the flotation reactant and atmospheric air to generate bubbles for flotation on self-aspirated flotation cells or compressed air to generate bubbles for flotation in columns or for flotation in mechanical cells with air insufflation.

9. “PROCESS FOR OBTAINING APATITE CONCENTRATES BY FLOTATION”, according to claim 3, characterized by using carbon dioxide gas as the flotation reactant and atmospheric air to generate bubbles for flotation on self-aspirated flotation cells or compressed air to generate bubbles for flotation in columns or for flotation in mechanical cells with air insufflation.

10. “PROCESS FOR OBTAINING APATITE CONCENTRATES BY FLOTATION”, according to claim 4, characterized by using carbon dioxide gas as the flotation reactant and atmospheric air to generate bubbles for flotation on self-aspirated flotation cells or compressed air to generate bubbles for flotation in columns or for flotation in mechanical cells with air insufflation.
